(19) United States
(12) Patent Application Publication
(10) Pub. No.: US 2025/0231291 A1
(43) Pub. Date: Jul. 17, 2025

(54) METHOD FOR POSITION FINDING RELATIVE TO AN ANCHOR NETWORK USING UNIDIRECTIONAL COMMUNICATION

(71) Applicant: Lambda:4 Entwicklungen GmbH, Hamburg (DE)

(72) Inventor: Rönne REIMANN, Hamburg (DE)

(73) Assignee: Lambda:4 Entwicklungen GmbH, Hamburg (DE)

(21) Appl. No.: 18/691,070

(22) PCT Filed: Apr. 28, 2023
(86) PCT No.: PCT/EP2023/061372

§ 371 Date: Mar. 12, 2024

(51) Int. Cl. G01S 13/84; G01S 13/75

(52) U.S. Cl. CPC G01S 13/84; G01S 13/75

(57) ABSTRACT

The application relates to the position finding of an active or passive radio node against a network of at least two anchors, the object of the present invention is to make such methods simpler, more reliable, more flexible and/or faster. This can be achieved in particular by dispensing with time synchronization between the anchors and the radio node, while the anchors are time-synchronized with one another. In addition, the necessary communication can be further reduced by unidirectional ranging. A unidirectional transmission with frequency change from the radio node to at least two anchors or from at least two anchors to the radio node is sufficient. By contrast with the known unidirectional ranging between an active and a passive object, time synchronization between active and passive objects can be dispensed with if either two time-synchronized active objects or one active and two time-synchronized passive objects are used.

The application relates to the position finding of an active or passive radio node against a network of at least two anchors, and to the synchronization of frequencies and times of two objects, for example anchors

Various such systems are known, for example as GPS or from WO2022096515 A1 and EP 2710398 B1.

The unidirectional determination of distance is also known, for example from WO2022096091 A1.

The object of the present invention is first to make such methods simpler, more reliable, more flexible and/or faster. This can be achieved in particular by dispensing with time synchronization between the anchors and the radio node, while the anchors are time-synchronized with one another. In addition, the necessary communication can be further reduced by unidirectional ranging. A unidirectional transmission with frequency change from the radio node to at least two anchors or from at least two anchors to the radio node is sufficient. By contrast with the known unidirectional ranging between an active and a passive object, time synchronization between active and passive objects can be dispensed with if either two time-synchronized active objects or one active and two time-synchronized passive objects are used.

The object is achieved by a method, an anchor network and an anchor network together with at least one, in particular a plurality of, active and/or passive radio nodes, configured to carry out the method. In particular, each anchor and each radio node comprises a control unit, a transmitting and/or receiving device.

The method according to the invention is designed to determine a position and/or a direction and/or a difference in distance of an active and/or a passive radio node at least relative to an anchor network comprising at least two anchors, wherein the at least two anchors are time-synchronized with one another or relative to a common timer. In particular the method is used indoors at distances between anchor and radio node of less than two kilometers, in particular less than 200 m, and/or with approximately unchanged radio channel properties during the application of the method or at least during the runtime of a signal between anchor and radio node The method is employed particularly advantageously with respect to a plurality of radio nodes, in particular more than 20 radio nodes, and/or is used for tracking a plurality of radio nodes and/or applied with respect to a plurality of anchors, in particular at least five, in particular a plurality of pairs of anchors.

In this case it is particularly preferable to employ the method using passive radio nodes, in particular radio node pairs. Passive radio nodes are in particular radio nodes that do not transmit signals for measuring distance or differences in distance. This does not mean that the radio nodes do not, for example, transmit measurement results by radio and/or communicate for other purposes. For example, in particular a cell phone that passively finds its position relative to the anchor network, as is the case with GPS positioning, for example, but maintains for example a data connection for receiving and transmitting user data, would be passive in this sense.

According to the invention, the radio node and/or the at least two anchors of the anchor network each transmit position-finding radio signals and thereby switch between at least two, in particular between at least five, frequencies, with phase relationship between the signals before and after switching being known. This can be done by measuring the relationship or by other means by which the relationship is determined. For example, switching can be performed without a phase jump.

According to the invention, the direction, position and/or a difference in distance is determined, in particular exclusively, on the basis of
measured phase or phase and amplitude of received position finding radio signals and
the known phase relationship and
information on the time offset of the frequency changes between the anchors and on the frequencies and, depending on the application of the method, also information on at least the relative position and/or the distance between the at least two anchors of the anchor network.

The exceptional feature of this is that even without time synchronization between the radio node on the one hand and the anchor network on the other hand, it is possible to determine the difference in distance between the distances from the radio node to the individual anchors, even with only unidirectional signal exchange between the radio node on one hand and the anchor network on the other hand. This enables not only the use of passive radio nodes, but also the simultaneous determination of multiple and/or by multiple radio nodes, as well as short measuring times.

The differences in distance can then be used together with other information, such as the distance between the anchors, to determine further information, such as the direction to the radio node, distance from and/or position of the radio node. This information can be determined in the anchor network, in the radio node and/or in an external computing unit.

The anchors can, for example, transmit their signals at the frequencies f1,1 to f1,n for anchor 1 with the frequencies 1 to n and analogously for the other x anchors, i.e. f1, 1 to fx,n, whereby the frequencies 1 to n of the anchors can be at least approximately identical, so that in abbreviated and approximated form we can speak of the frequencies f1 to fn. Approximately identical frequencies exist in particular if they are considered identical due to the existing synchronization, their deviation is not greater than the current CFO and/or their difference is not more than 100 MHZ.

The anchors can switch between the frequencies at the times t1,2 to tx,n, where t1,2 refers to the switching of anchor 1 from the first to the second frequency.

This does not depend on absolute times, but can be relative to any time, for example in the anchor network, at which the radio node does not have to be synchronized.

However, the radio node can also, alternatively or additionally, transmit signals on the frequencies f1 to fn with the frequencies f1 to fn.

The radio node can switch between the frequencies at the times t1,2 to t1,n, where t1,2 refers to the switching of radio node 1 from the first to the second frequency.

This does not depend on absolute times, but can be relative to any time, for example in the radio node, at which the anchor network does not have to be synchronized.

The radiation of the signals at different frequencies, but also the switching, can take place with or without interruption. It is only important that the phase position of the signals in relation to each other is known before and after switching; this requires information on the time of a-possibly virtual-switch, and the relative phase position before and after switching. One and the same physical sequence for radiation with interruption during switching can therefore be specified with different combinations of relative phase position and switching time (within the interruption).

If the radio node transmits, the anchors are receivers; if the anchors transmit, the radio node is the receiver. The receiver(s) receive(s) the signals at different frequencies and measure(s) its/their phase position or its/their amplitude and phase position. The phase positions can, for example, be designated as phi1,1 to phix,n. If the anchors transmit, the radio node measures the signals of anchors 1 to x on their respective frequencies 1 to n; if the radio node transmits, the anchors 1 to x measure the signals of the radio node on the frequencies 1 to n.

The calculation can be carried out as follows, for example:
1. Calculate the distance between anchor 1 and the radio node as if both were time-synchronized.
2. Calculate the distance between anchor 2 and the radio node as if both were time-synchronized.
3. Calculate the difference in distance, eliminating the “unknown” time difference.

In multipathing environments, it is advantageous to search for the shortest signal path (the shortest distance recognizable in the signal) using FFT and/or high-resolution methods such as MUSIC or CAPON. These shortest distances are then subtracted. In particular, the signal components of the shortest path between an anchor and the radio node are isolated using FFT and/or high-resolution methods and the respective distance is determined based on this.

An angle, i.e. a relative orientation, of the radio node to the connecting line between two anchors can also be determined.

The object is also achieved by an anchor network comprising at least two anchors, whereby the at least two anchors are time-synchronized with one another or with a common timer. In particular, the anchors have means for receiving and/or transmitting radio signals. Furthermore, the anchor network has at least one control unit which is set up to control the anchors in order to carry out the method, in particular the anchor-side part of the method.

The object is also achieved by a system comprising an anchor network and at least one, in particular a plurality of, radio nodes. In particular, the radio nodes have means for receiving and/or transmitting radio signals. Furthermore, the radio node(s) has/have at least one control unit which is set up to control the respective radio node to carry out the method, in particular the part of the method on the radio node side.

Furthermore, the anchor network or the system preferably has a computing unit to determine the position and/or direction and/or difference in distance. The computing unit can be part of the anchors and/or of the radio node.

In particular, the anchors are approximately or completely stationary at least for the duration of the signal exchange for determining a difference in distance. This can be achieved, for example, by fixing the anchors to solid structures or by placing the anchors on solid structures. However, holding them still in human hands can also sufficiently fulfill the requirement. In particular, the consistency of the measurement can also be determined by the anchors determining their distances and/or positions before and after the signal exchange and comparing these. A metric can be determined for the accuracy or consistency, for example based on the deviations of the distances and/or positions before and after the signal exchange.

A channel analysis is preferably performed on the received signals to determine the position, direction and/or difference in distance in order to determine the signal component of the shortest signal path assumed on the basis of the channel analysis and, in particular, the phase and/or amplitude measurement is used in particular for this signal component only. The channel analysis can, for example, be carried out using an FFT, whereby in particular the first relevant maximum is searched for in the pseudo spectrum obtained and is assumed to be the shortest signal path.

With particular advantage, the change in phase shift during a frequency change or its ratio to the frequency difference of the frequency change is used to determine the position, direction and/or difference in distance. The absolute phase position is therefore not required.

The time difference between the radio node and the anchor network is preferably not determined and/or is not known, at least not with an accuracy of at least 50 ns, and/or the relative time between the anchor network and the radio node is not used to determine the position and/or direction. Although it is not an advantage that (precise) time synchronization is not available, it is a considerable advantage to be able to dispense with it.

A time shift will be present in all measurements between anchor network and radio node and therefore cancels itself out when determining the difference in distance. A drift of this time shift due to clocks/quartz crystals with different speeds in the radio node and anchor network can also be detected and corrected. It is preferable if the signals for determining a difference in distance are exchanged in a time window that is so small that the (relative) drift of the clocks in the anchor network and radio node is approximately constant and/or the error resulting from the change in drift in the time window is in particular less than 3 ns, in particular less than 0.3 ns.

Time synchronization within the anchor network can take place in various ways. Synchronization is possible between the anchors alone or relative to another timer. This can be cable-based or radio-based. In a preferred embodiment, depending on the application, the time synchronization between the anchors of the anchor network is radio-based, in particular by determining differences in the phase shifts or phase shifts and amplitudes on the outward and/or return path of the transmission between pairs of anchors, in particular also by means of in-line phase return of the negated measured phase.

For distance determination, working with in-line phase return is state-of-the-art, using the measured phase on a received signal and modifying the phase of the response signal transmitted in response based on the measured phase by adding the measured phase to a predetermined phase position and transmitting the response signal with the phase position obtained by this addition. Returning the response signal with exactly the phase of the received interrogation signal is known from U.S. Pat. No. 8,446,254 B2, for example, but this still has the disadvantage that it lacks time information. This can also be seen as a corresponding in-line phase return, in which, for example, the received phase of the interrogation signal is always added to the phase zero for the transmission of the response signal. If the predetermined phase here were not zero, but that of a PLL whose phase position relative to the common time is known, this would offer further advantages.

For time synchronization and/or determination of a deviation between timers, but alternatively or additionally also for frequency synchronization and/or determination of a frequency deviation of local PLLs of the objects, the method also uses an in-line phase return as a separate invention between two objects (e.g. first and second anchor) with a known phase relationship of the transmitted signals and/or PLLs, in particular relative to the respective local timer of the two objects, whereby the addition is replaced by a subtraction. This enables the synchronization and/or determination to be carried out particularly quickly, especially if the distance and/or the radio signal path length(s) between the two objects is/are known. Preferably, the transmitted radio signal is broken down into signal path components and one or more signal path components are always considered separately for the following determinations, in particular one or more whose radio signal path length(s) is/are known. Alternatively or additionally, known methods can be used to try to reduce multipathing, for example by selecting suitable frequencies.

If, for example, the phase positions relative to the local timers of the two objects are known, i.e. the phase position of the PLL or the transmitted signals of the first object to the timer at the first object and the phase position of the PLL or the transmitted signals of the second object to the timer at the second object are known, the synchronization of the two timers can be achieved quickly and easily using in-line phase return. It can also be used to determine the frequency deviation of the PLLs of the two objects.

The frequency offset between the PLLs of the two objects (crystal frequency offset, CFO), which can be used directly for frequency synchronization, can be determined using the following equation, for example:

$$CFO = 1 / 2 * dPhase ( t 2 , t 1 ) / ( 2 * Pi ) / ( t 2 - t 1 ) ,$$

where dPhase (t2,t1) is the measured change between the phase shifts of two response signals of the second object, said second object having transmitted these two response signals to the signals transmitted at the first object at time t1 and at time t2 of the timer (one to the signal transmitted at time t1 and one to the signal transmitted at time t2) and these two response signals having been received at the first object, and the second object, when transmitting the response signals, having already subtracted the phase previously received there of the signals transmitted at times t1 and t2, respectively, from the phase position known per se relative to the timer of the second object. t2 from the phase position known relative to the timer of the second object. The phase shift is the phase shift caused by the radio channel and/or the transmission of the signals during the round trip (one signal each from the first object to the second and from the second to the first). The change in the phase shift is then understood to be the change in the phase shift from the first (started at t1) to the second (started at t2) round trip.

A larger time interval between the round trips and/or t1 and t2 results in greater accuracy and is therefore preferable. Attention must be paid to the unambiguity of (2*Pi)/2. In other words, depending on how precisely the CFO was already known before the measurement, the time interval can be optimized so that it is chosen to be large, but the unambiguity is reliably maintained. In practice, especially with an existing CFO of 100 Hz or better (lower), time intervals between t1 and t2 or the round trips in the range of 0.3 to 50 ms have proven to be successful, whereby further measurements with increasing time intervals are preferably carried out subsequently, in which accuracies achieved on the basis of the previous measurement(s) are taken into account in each case in order to determine the time intervals in such a way that unambiguity is ensured.

The frequencies of the signals transmitted at time t1 and at time t2 of the timer at the first object are preferably selected to be identical and the frequencies of the response signals of the second object to the signals transmitted at time t1 and to the signal transmitted at time t2 of the timer at the first object are also selected to be identical, in particular also approximately identical to the frequencies of the signals transmitted at time t1 and at time t2 of the timer at the first object. This means, in particular, that they were matched as closely as was possible with the information available.

If the time synchronization is accurate and the distance and/or signal path length is known, the process can also be carried out unidirectionally and even with only one signal on one frequency. If a signal with a frequency and known phase position is emitted at the first object at a known time, the expected phase position at the second object can be calculated. If the real phase position is measured, the CFO can be calculated from this. However, all errors in the signal path length, time synchronization and phase measurement then play a direct role in determining the CFO.

Preferably, the method is repeated at several different frequencies (e.g. fa and fb) at different times (e.g. ta for the start of the application at frequency fa and tb for the start of the application at the frequency fb; t1 is then in particular equal to ta in each case). The frequencies preferably do not have linear spacing from the time of measurement (e.g. ta and tb) or have only a low linear dependence, in particular of less than 10%. A low linear dependence exists in particular if the two-dimensional vectors, each consisting of frequency and transmission time, have a linear component of less than 10% relative to one another. This is the case, for example, in pairs of two such vectors if the projection of one onto the other has a length of less than 10% of the length of the one.

In particular, with fb−fa=Kab*(tb−ta) for different pairs fa and fb, it is therefore the case that Kab is not the same for all pairs, and in particular is different for all pairs. In another preferred, but technically more sophisticated embodiment, the process is carried out at several frequencies simultaneously.

The time difference (dT) that can then be used directly for synchronization can be determined, for example, using the following calculation:

$$dT = 1 / 2 * dPhase ( f 2 , f 1 ) / ( 2 * Pi ) / ( f 2 - f 1 ) ,$$

where dPhase is the measured change between the phase shifts of two response signals of the second object, said second object having transmitted these two response signals to the signals transmitted at the first object at the frequency f1 and frequency f2 (first signal at f1, second signal at f2) and these two response signals (one to the signal transmitted at f1, also with approximately frequency f1, and one to the signal transmitted at f2, also with approximately frequency f2) having been received at the first object, and, said second object, when transmitting the response signals, having in each case already subtracted the phase previously received there of the signals transmitted by the first object from the phase position known per se relative to the timer of the second object, i.e. in particular having in each case rotated the transmitted phase of the response signals by the negative received phase of the signal previously received in each case. One response signal here is the response signal transmitted to the signal sent at frequency f1 and one response signal is the response signal transmitted to the signal sent at frequency f2.

The measurement of the round trip of the first signal at f1 and the corresponding response signal and the measurement of the round trip of the second signal at f2 and the corresponding response signal is advantageously carried out with a time interval in which the channel has not changed significantly, in particular at the same time. A CFO also leads to deviations if the measurements are not performed at the same time. Although the deviation can be calculated arithmetically if the CFO is approximately known, it is advantageous to avoid it or keep it small. In practice, a maximum time interval of 100 ms has proved to be successful.

Signals for determining the frequency deviation and/or frequency synchronization are advantageously also used to determine the time difference and/or time synchronization, or vice versa. In particular, frequency hopping is used for this purpose, especially with non-equidistant frequency intervals and/or with frequency intervals that are small or non-linear compared to the transmission time. This is therefore a method for in particular determining the frequency deviation and/or frequency synchronization on the one hand and for determining the time difference and/or time synchronization on the other.

The methods are preferably repeated individually or together with several different frequency pairs (e.g. several pairs fa and fb) at identical or different times (e.g. ta1 for the start of the process at fa1 and fb1 and ta2 for the start of the process at frequencies fa2 and fb2). The frequencies and/or frequency differences preferably exhibit little or no linear dependence with respect to the time of measurement.

In particular with (fb1−fa1)/(fb2−fa2)=K12*(ta1−ta2) for different pairs of pairs fan/fbn and fam/fbm, it therefore holds true that Knm is not the same for all pairs, and in particular is different for all pairs of pairs.

In another preferred, but technically more sophisticated embodiment, the process is carried out with several pairs of frequency pairs simultaneously.

The exchange of radio signals between the anchors for time synchronization takes place in a preferred embodiment, in which fast switching between the emission frequencies is possible, in particular in relation to the time for switching the transmit amplifier on and off, so that first one object (e.g. first anchor) transmits, in particular one after the other, on different frequencies and then another object (e.g. second anchor) transmits, in particular one after the other, on different frequencies. As a result, the time required can be reduced.

The exchange of radio signals between the objects for time synchronization takes place in another preferred embodiment, in which there is a slow switch between the emission frequencies, in particular in relation to the time for switching the transmitter amplifier on and off, so that the objects only transmit one signal at a time on one frequency, i.e. they always alternate. As a result, the time required can be reduced.

In a further preferred embodiment in which the, in particular continuous, time synchronization of the objects/anchors, in particular after an initial (possibly also arbitrary) time synchronization, is performed at and/or during an approximately constant radio channel (reference channel) (e.g. if the average distance of the transmitted energy of the radio channel changes by less than 1 m, in particular by less than 10 cm, at and/or during the time synchronization and/or the time synchronization is carried out in such a way that this condition is met) between the anchors can be radio-based, this is preferably carried out in such a way that the, in particular continuous, time synchronization is carried out between two anchors, in particular repeatedly and/or continuously, by means of unidirectional signal exchange at several frequencies and on the basis of phase measurements on the exchanged unidirectional signals.

This can be done, for example, using the following calculation:

If dPh(F2,F1) is the relative (i.e. standardized to the difference between the frequencies F1 and F2) change in the phase shift (caused by the transmission channel) between the two unidirectional signals at F1 and F2 measured on received unidirectional signals at frequencies F1 and F2, for example from the first to the second anchor, if ddPh((F2,F1), t2, t1) is the relative phase shift difference, i.e. the phase shift measured at time t2 corrected for the effect of the transmission channel, i.e.

$$ddPh ( ( F 2 , F 1 ) , t 2 , t 1 ) = dPh ( F 2 , F 1 ) ( t 2 ) - dPh ( F 2 , F 1 ) ( t 1 )$$

with dPh(F2,F1) (t2) as dPh(F2,F1) of a signal transmitted or received at time t1 and dPh(F2,F1) (t1) as dPh(F2,F1) of a signal transmitted or received at time t2, then ddPh( ) is proportional to the shift dT of the time base between the objects/anchors between the times t1 and t2.

The time shift dT can therefore be calculated as:

$$dT = ddPh ( ( F 2 , F 1 ) , t 2 , t 1 ) / ( 2 * pi ) / ( F 2 - F 1 )$$

The change in the measured phases, in particular phase shifts, in particular at a plurality of frequencies, is therefore preferably considered with the “reference measurement” with known time synchronization (t1). By measuring at different frequencies, the distance between which is preferably large, in particular in the range of 50-500 MHZ, a particularly error-tolerant determination can be made, which in particular makes less demands on the CFO and the previously existing coarse time synchronization and yet avoids the ambiguity problem quite reliably, because a measurement is made virtually, so to speak, only at the difference in frequency. For example, if the measurement is made in the 2.4 GHz band with the frequencies 2400 and 2480 MHz, the difference is only 80 MHz. Then 12 ns correspond to 360° phase rotation, so that with an accuracy of the phase measurement in the range of +/−3 to 6° a quite good time synchronization can be achieved and this with only low demands on the avoidance of ambiguity problems with regard to the phase position.

The rate of change of time synchronization from time t1 to time t2 is then:

$$ddT = dPh at time 2 - dPh at time 1 = ddPh ( ( F 2 , F 1 ) , t 2 , t 1 ) / ( t 2 - t 1 ) .$$

ddPh((F2,F1),t2, t1) can also be replaced by an averaging of several ddPh((Fn,Fm),t2, t1) with several frequency pairs Fn,Fm. This can increase the accuracy.

ddPh is therefore the change in the phase shift measured at the second object (previously adapted for the phase shift caused by the transmission channel) between signals received at the second object that were transmitted at the first object at times t1 and t2.

If the measurement configuration is sufficiently accurate, in particular if the signal path length is known with sufficient accuracy, the CFO is sufficiently small and the phase measurement is sufficiently accurate, the time deviation can also be determined simply using a unidirectional signal. If a signal with a known phase position is emitted from the first object at a known frequency and its phase position is determined at the second object, this can be compared with the expected phase position and dT can be determined directly from the deviation. However, especially at high frequencies, this requires a high level of accuracy in order to avoid ambiguity.

Sufficient accuracy is achieved if the ambiguity of the phase measurement can be reliably avoided. This can be determined arithmetically based on the frequency used.

In general, the frequencies used in this text are preferably above 2 GHz. This enables a high level of accuracy to be achieved and allows existing transmitters, such as Bluetooth, Wi-Fi and/or mobile communications, e.g. LTE, to be used.

Advantageously, the distance between the anchors/objects and/or their relative position is determined by means of radio-based distance measurements between two of the anchors/objects in each case. This means that other measurement methods, such as manual or light-based methods, can be completely dispensed with. This reduces the amount of equipment required. It also makes it possible to set up anchor networks quickly and easily, for example on an ad hoc basis. This can be helpful, for example, in emergency situations for tracking down a radio node such as a cell phone. For example, a group of people each carrying a radio node, for example in the form of a cell phone, can set up an anchor network using the radio nodes of the remaining people if one of the people is lost or buried, and the radio node of the lost or buried person can be located promptly. For this purpose and in general, the radio nodes can, for example, determine their relative position using GPS and/or radio-based distance measurement. After an initial determination, the position of some or all anchors can also be adapted in order to improve the determination in a further application of the method. This allows precise localization to be achieved very quickly and reliably. For this purpose, the position of the anchors is changed, in particular iteratively, so that they are arranged around the radio node to be located, in particular evenly. For this purpose, some or all of the anchors can move towards the approximate position between measurements, in particular from different sides, while maintaining a minimum distance, in particular a predetermined distance, between the anchors, of e.g. 2 m.

It is preferable if the anchors adapt the phase of the emitted signals based on a time difference between the anchors so that the signals of the anchors appear to be emitted coherently. In a simple embodiment, the anchors transmit their signals at fixed times relative to their respective local timer, which also leads to deviations due to drift during time synchronization. However, a non-coherent anchor system can also appear from the outside due to known phase jumps when switching and also due to different phase positions of the transmission from different anchors. This can be changed by slightly altering the switching times so that the anchor system appears coherent from the outside, at least above a certain distance from one another. This simplifies the necessary calculations.

If is particularly advantageous for simple installation if the or certain of the anchors are part of, in particular fixed, loudspeakers and/or lamps and/or of the other electrical infrastructure installed or operated in buildings or rooms (also: plug sockets, switches, smoke detectors, etc.).

Advantageously for the accuracy and robustness of the method, the radio node communicates with the at least two anchors via a plurality of antenna paths and/or the anchors communicate with each other in pairs via a plurality of antenna paths. An antenna path is, in particular, the radio channel from a first transmitting antenna to a first receiving antenna. If, for example, two antennas, e.g. of an anchor, are used for reception and the signals received are evaluated separately, two antenna paths are used. If a second transmitting antenna, for example of the radio node, is then also used, for example downstream in time, and received in each case with the two receiving antennas, four antenna paths are used.

In certain applications, it is preferable to build the anchor network with mobile devices ad hoc and that the anchors in particular first determine information on their relative arrangement, and in particular do this repeatedly. In this way, a solid anchor network and a determination can be carried out quickly; this is possible with active and/or passive radio nodes.

Depending on the application, it is generally preferable to work with active and/or passive radio nodes. Passive radio nodes are advantageous, for example, if a large number of radio nodes are used simultaneously and/or the radio node(s) are to remain anonymous and/or undetected. The use of active radio nodes can be advantageous if they are to consume as little electrical power as possible, i.e. only transmit briefly and do not receive for long periods. The combination of active and passive determinations for a radio node can utilize the advantages of both variants.

The following descriptions explain the inventions purely by way of example using the purely schematic figures. Here:

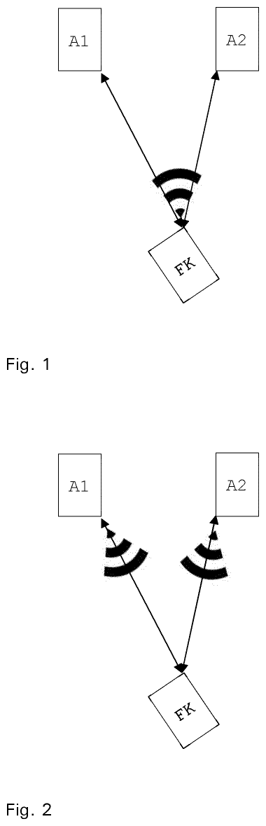

FIG. 1 shows an illustration of an anchor network and an active radio node;

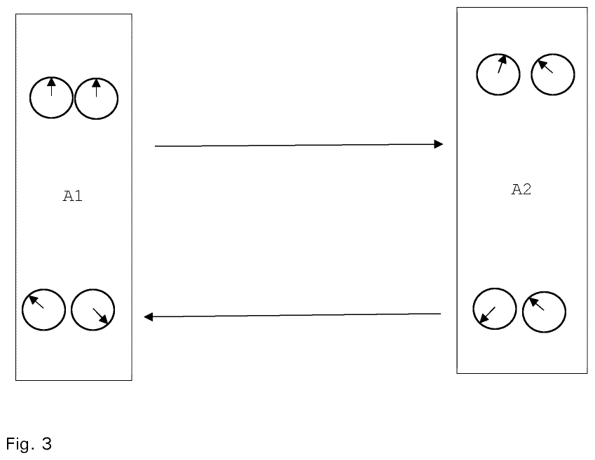

FIG. 2 shows an illustration of an anchor network and a passive radio node, and

FIG. 3 shows an illustration of a time synchronization using in-line phase return.

FIG. 1 shows an anchor network with two anchors A1, A2 with fixed positioning and a known spacing between them. The radio node FK transmits unidirectional signals which are received by the anchors A1, A2. These are used to determine the difference between the distances indicated by the double arrows. If the method is carried out with a plurality of anchors, for example three or four, and their positions are known, the position of the radio node can be determined in 2 or 3 dimensions.

FIG. 2 shows an anchor network with two anchors A1, A2 and a passive radio node FK, which receives the unidirectional signals from anchors A1, A2 and determines the difference between the distances indicated by the double arrows. If the method is carried out with several anchors, for example three or four, and their positions are known, the position of the radio node can be determined in 2 or 3 dimensions.

FIG. 3 shows an illustration of the time synchronization by means of in-line phase return between two objects A1, A2, which can be anchors of an anchor network. The objects each have local timers and a PLL, which are preferably set to approximately the same frequencies and whose phase position is known in relation to the respective local timer of the object, assumed here to be identical for the sake of simplicity, and whose phase is shown for each anchor at two times Ta, Td for object A1 and Tb, To for object A2 by arrows in a circle, the outer circle in each case. The arrows in the inner circles (A1 right, A2 left) indicate the phase of a signal. The arrows between the objects indicate signals, the upper one a first signal from the first object A1 to the second object A2 and the lower one a second signal from the second object A2 to the first object A1. The first object sends a signal starting at time Ta with the phase position of the internal PLL, therefore the pointers are identical. This signal start is received at time Tb at the second object, with a phase position indicated by the upper left arrow, while the internal PLL of the second object A2 has the phase indicated by the upper right arrow. The second object begins to transmit the second signal at time Tc, which was assumed to be approximately equal to Tb for the sake of simplicity. Without in-line phase return, this signal would be sent with the phase of the PLL. For the in-line phase return, however, it is now rotated by the negated deviation of the received first signal to the PLL of the second object and thus sent starting with a deviating phase position, indicated by the lower left arrow in the second object. The first object receives the signal and determines the phase position of the start of the signal in relation to its own PLL. From this, together with the phase of the start of transmission of the first signal, it can determine the phase shift through the radio channel of the round trip.

If the distance is constant and known, the relative change in the timers of the objects can be determined. If the distance is constant, the difference between the timers of the objects can be determined by repetition. This is because the phase position determined at the first object on the second signal can be compared with the calculated phase position for synchronous timers This allows the difference between the timers to be determined.

1. A method for determining a position, a direction, or an at least one difference in a distance of an active or a passive radio node; wherein the distance is at least relative to an anchor network comprising at least two anchors, wherein the at least two anchors are time-synchronized with one another or relative to a common timer, and whereby a radio node or the at least two anchors of the anchor network each transmit position-finding radio signals and thereby switch between at least two frequencies with a known phase relationship and whereby the direction or position is determined on the basis of
measured phase or phase and amplitude of received position-finding radio signals and
the known phase relationship and
information on a time offset of the frequency changes between the at least two anchors and on the frequencies
the at least one difference in the distance or together with
information on an at least relative position or the distance between the at least two anchors of the anchor network.

2. The method according to the claim 1, wherein the radio node transmits the position-finding radio signals and the at least two anchors receive the position-finding radio signals and measure their phase or their phase and amplitude.

3. The method according to claim 1, wherein the at least two anchors transmit the position-finding radio signals and the radio node receives the position-finding radio signals and measures their phases or their phases and amplitudes.

4. The method according to claim 1, wherein the change in a phase shift at a frequency change or the phase shift's ratio to the frequency difference is taken as a measured phase of the received position-finding radio signals.

5. The method according to claim 1, wherein a time difference between the radio node and the anchor network is not known, at least not with an accuracy of at least 50 ns, or a relative time between the anchor network and the radio node is not used to determine the position or direction of the active or passive radio node.

6. The method according to claim 1, wherein the time synchronization between the at least two anchors of the anchor network is radio-based.

7. The method according to claim 1, wherein the distance between the at least two anchors or their relative position is determined by means of radio-based distance measurements between pairs of the anchors.

8. The method according to claim 1, wherein the at least two anchors adapt the phase of the transmitted signals such that the signals of the at least two anchors appear to be transmitted coherently.

9. The method according to claim 1, wherein the signal exchange takes place in such a way that first one anchor of the at least two anchors transmits on different frequencies and then another anchor of the at least two anchors transmits on different frequencies.

10. The method according to claim 1, wherein the time synchronization of the at least two anchors at or during approximately constant radio channel between the at least two anchors is radio-based by means of unidirectional signal exchange on several frequencies and on the basis of phase measurements on the exchanged signals.

11. The method according to claim 1, wherein the at least two anchors are part of loudspeakers or lamps or of other electrical infrastructure installed or operated in buildings or rooms.

12. The method according to claim 1, wherein the radio node communicates with the at least two anchors via a plurality of antenna paths or the at least two anchors communicate with each other in pairs via a plurality of antenna paths.

13. The method according to claim 1, wherein the anchor network is built with mobile devices ad hoc.

14. Anchor An anchor network created for carrying out the method according to claim 1 together with an active or passive radio node.

15. A method for time synchronization, frequency synchronization or determination of a time difference or frequency deviation between a first and a second object wherein the objects each have at least one local timer and at least one PLL and the relative phase position of two signals of different frequencies is known by means of the PLL of an object according to the time difference of the generation or transmission of the two signals at one of the objects relative to its timer or the phase position of the PLL of each of the objects at different frequencies is known relative to its timer, wherein the time synchronization, frequency synchronization or determination between the objects is carried out radio-based by means of phase measurement(s).

16. The method according to claim 15, wherein the time synchronization or determination of the time difference is performed by determining the phase shift of the transmission of forward signal from the first to the second object and return signal from the second to the first object by means of in-line phase return.

17. The method according to claim 16, wherein the in-line phase return is performed by changing the phase position of the return path signal relative to a phase position known with respect to the local timer of the second object by the negated measured phase of the forward path signal received at the second object.

18. The method according to claim 16, wherein a plurality of forward and return signals are exchanged with in-line phase return.

19. The method according to claim 15, wherein a time synchronization or determination of the time difference takes place and wherein the phase position of the second signal received at the first object is determined at the first object and is used together with the phase position of the first signal at the first object relative to the PLL of the first object for time synchronization.

20. The method according to claim 15, wherein the time synchronization or determination of the time difference is radio-based by means of unidirectional signal exchange from the first to the second object on several frequencies and on the basis of phase measurement on the signal received at the second object.

21. The method according to claim 20, wherein the method is carried out during or with an approximately unchanged radio channel or with an approximately known radio channel, distance or approximately known signal path length.

22. The method according to claim 20, wherein the relative difference of the phase shifts between the two unidirectional signals at the first and second frequencies caused by the transmissions, measured on received unidirectional signals at a first and a second frequency is used for time synchronization.

23. The method according to claim 15, wherein the frequency synchronization or determination of the frequency deviation is performed by determining the phase shift of the transmission of forward signal from the first to the second object and return signal from the second to the first object by in-line phase return.

24. The method according to claim 23, wherein the in-line phase return is performed by changing the phase position of the return path signal relative to a phase position known with respect to the local timer of the second object by the negated measured phase of the forward path signal received at the second object.

25. The method according to claim 23, wherein a plurality of forward and return signals are exchanged with in-line phase return.

26. The method according to claim 23, wherein
the phase position of the second signal received at the first object is determined at the first object and is used together with the phase position of the first signal at the first object relative to the PLL of the first object for frequency synchronization or determination.

27. The method according to claim 15, wherein the frequency synchronization or determination of the frequency deviation between the objects, is radio-based by means of unidirectional signal exchange from the first to the second object.

28. The method according to one of claim 15, wherein the method is carried out during or with an approximately unchanged radio channel or with an approximately known radio channel, distance or approximately known signal path length.

29. The method according to claim 27, wherein the relative difference of the phase shifts caused by the transmissions between the two unidirectional signals at the first and second time, measured at two different times on received unidirectional signals, is used as a measure of the deviation of the PLLs of the two objects.

30. The method according to claim 27, wherein the phase position of the unidirectional signal of the first object received at the second object is determined at the second object and the phase position of the first signal at the second object relative to the PLL of the second object is used for time synchronization.

31. The method according to claim 2, wherein the at least two anchors transmit position-finding radio signals and the radio node receives the position-finding radio signals and measures their phases or their phases and amplitudes.

32. The method according to claim 6, wherein the radio-based time synchronization between the at least two anchors of the anchor network is performed by means of determination of differences in the phase shifts or phase shifts and amplitudes on an outward and a return path of the transmission between pairs of anchors by means of in-line phase return of a negative measured phase or wherein the time synchronization of the at least two anchors is radio-based by means of bidirectional signal exchange and on the basis of phase measurements on the exchanged signals and by means of negated in-line phase return.

33. The method according to claim 13, wherein the at least two anchors first determine information on their relative arrangement.

34. The method according to claim 19, wherein the change in the difference between two outgoing and return path signal pairs exchanged at different frequencies or their change relative to the difference in frequency is used as a measure of the relative change in the local timers.

35. The method according to claim 20, wherein the phase position of the unidirectional signal of the first object received at the second object is determined at the second object and the phase position of the first signal at the second object relative to the PLL of the second object is used for time synchronization.

36. The method according to claim 26, wherein the change in the difference between two outgoing and return path signal pairs exchanged at different times and in particular at least approximately identical frequencies is used as a measure of the frequency deviation.
